(19) United States
(12) Patent Application Publication
(10) Pub. No.: US 2012/0109784 A1
(43) Pub. Date: May 3, 2012

(54) METHOD AND SYSTEM FOR AUTOMATING PROTECTION OF MEDIA FILES FOR DOWNLOAD

(76) Inventor: Dale Scott Marion, Simleu Silvaniei (CA)

(21) Appl. No.: 12/791,891

(22) Filed: Jun. 2, 2010

(51) Int. Cl. G06Q 30/06; H04L 9/08; G06F 12/14

(52) U.S. Cl. 705/27.1; 726/30; 713/189; 380/279; 726/22

(57) ABSTRACT

Method and apparatus for providing copyright protection of downloaded media files (audio, video or images) is provided. The method and apparatus specifically comprise wrapping the copyrighted media file into an executable wrapper along with information about the media, information about the user downloading the media, information about the usage of the media, a media player, helper scripts and any sets of keys used to encrypt the media file or the other information. The present invention also includes running this executable wrapper on the user's computer to decrypt and extract the wrapper and its various components provided user enters a valid pass code. The components of the wrapper make sure that the media can be played only for the requested period and in the prescribed or pre-arranged manner. The helper scripts are used on the user's computer to scramble the media when it is incorrectly or maliciously accessed, to delete the media when the rental duration expires and to monitor other processes on user's computer that may record or store unprotected media.

### PRIOR APPLICATION

The present invention claims priority to U.S. provisional application, entitled “______”, filed on Jun. 3, 2009 (?) and assigned Application No. ______.

### BACKGROUND OF THE INVENTION

1. Field of the Invention

Embodiments of the present invention generally relate to copyright protection of media and, more particularly, to a method and apparatus for protecting copyrighted audio, video and image files for downloading from a network like Internet.

2. Description of the Related Art

Protection of media files is usually done by encrypting the media file with a master key and then encrypting the master key with a user-specific key. This user-specific key could either be provided by the user or automatically generated by the protection system. This user key is then stored in an encrypted form within the media playing device or software, so that it can be retrieved easily for decrypting the master key and then decrypting the media file. This approach, although simple, is easy to crack and makes unrestricted distribution of media files almost trivial. Another approach used for protection of media is to contact media protection servers every time the media is played. This is very restrictive for the users and reduces the perceived value of the media.

Therefore, there is a need in the art for a better system and method of protecting media that is available for download from networks like Internet.

### SUMMARY OF THE INVENTION

Embodiments of the present invention comprise a method and apparatus for automating protection of media files for download from a network. The method and apparatus specifically comprise encrypting the media file, then encrypting the keys of previous encryption stage, encrypting user information and a user pass code, and wrapping all this information into an executable file along with a software application that can play the concerned media file, a script that can delete the media, a script that can scramble the media and a script that can detect if the media is being copied or recorded in a unprotected manner.

### BRIEF DESCRIPTION OF THE DRAWINGS

The following detailed description makes reference to the accompanying drawings that are now briefly described.

FIG. 1 depicts the block diagram of a computer network that operates in accordance with the present invention to provide a system for protection of media for download;

FIG. 2 depicts a flow diagram of a method that, according to present invention, enables a server computer to protect a media file and then present it to the user in response to a download request from a user computer;

FIG. 3 depicts a flow diagram of a method that, according to present invention, enables a user on his computer to either play a protected media file if he provides a correct pass code, or to destroy it if he provides an incorrect pass code;

While embodiments of the invention are described herein by way of example using several embodiments and illustrative drawings, those skilled in the art will recognize that the invention is not limited to the embodiments. It should be understood that the drawings and detailed description thereto are not intended to limit the invention to the particular form disclosed, but on the contrary, the invention is to cover all modification, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

### DETAILED DESCRIPTION

The teachings of the present invention can be readily understood by considering the following detailed description in conjunction with the accompanying drawings, in which:

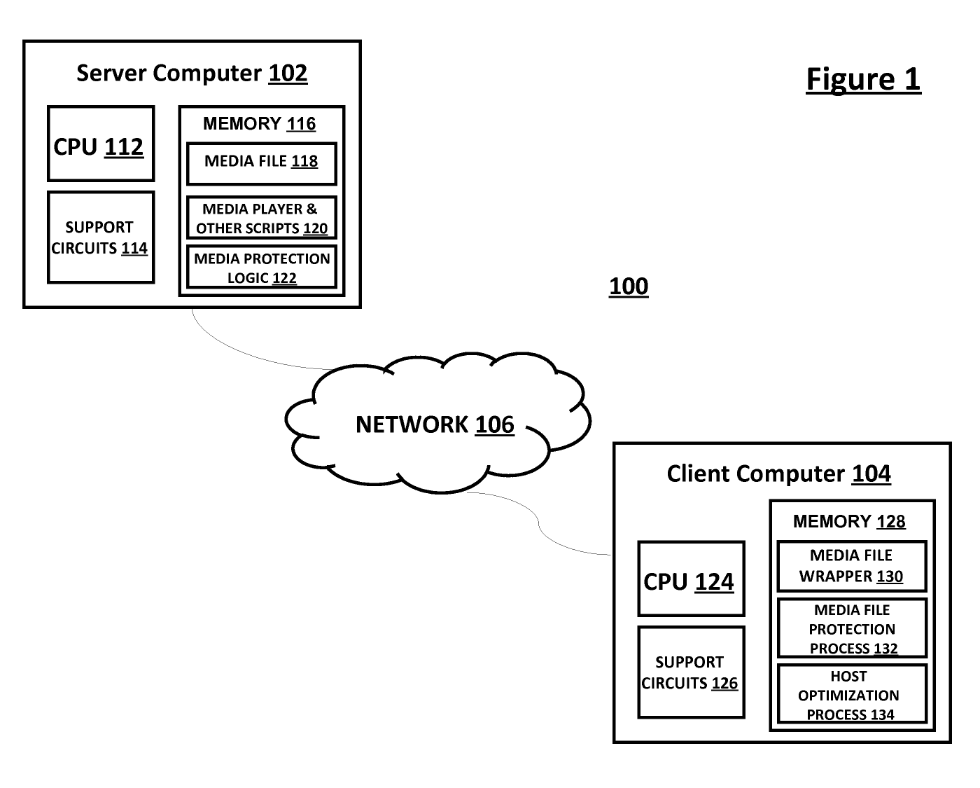

FIG. 1 depicts a computer network 100 in which the embodiments of the present invention may be utilized to provide media for download with copyright protection. This computer network is configured to permit a client computer 104 to access a server 102 through a network 106. The server computer 102 applies suitable protection to the media files and serves the protected media to its clients using suitable software (e.g. web server). The client computer 104 utilizes a suitable software (e.g. web browser) to access and manipulate the server 102 to enable the client computer 104 to download a protected media file, and then have that media file played for the user according to the server-applied protection.

More specifically, the computer network 100 comprises a client computer 104 (also referred to as a user computer) coupled to a communications network 106 (e.g. Internet) that enables the client computer 104 to communicate with a server computer 102. The communications network 106 comprises well-known network infrastructure that supports the Internet, a wide area network, or a local area network.

The client computer 104 comprises a central processing unit (CPU) 124, support circuits 126 and a memory 128. The CPU 124 may comprise one or more conventionally available microprocessors. The support circuits 126 are well-known circuits used to promote functionality of the CPU 124. The support circuits 126 may comprise such circuits as clock circuits, power supplies, cache, input/output circuits, network interface circuits, and the like.

The memory 128 is coupled to the CPU 124 and may comprise random access memory, read only memory, removable disk memory, flash memory, and various combinations of these types of memory. The memory is sometimes referred to as main memory and may, in part, be used as cache memory or buffer memory. The memory 128 generally stores an operating system, browser software and optionally may have received and stored within its memory a user downloaded media file wrapper 130. Hereinafter, the terms media wrapper file, wrapper, wrapper file, protected media, protected file and media wrapper are used interchangeably to mean a copyright protected media file along with any software and user configuration information related to the media protection system. The wrapper file would generally be stored upon a disk drive (herein considered part of the memory 128). The operating system may be one of a number of commercially available operating systems such as, but not limited to, Windows from Microsoft Corporation, Mac OS from Apple Inc., Linux from Red Hat Software, and the like. The client computer 104 uses the CPU 124 to execute an operating system in 128 to support a browser or client logic, the browser will connect through the network 106 to the server 102.

The server 102 comprises central processing unit (CPU) 112, support circuits 114, and memory 116. The CPU 112 may be one or more of a number of conventionally available microprocessors. The support circuits 114 promote functionality of the CPU 112 and may comprise such circuits as cache, power supplies, clock circuits, input/output (I/O) circuits, network interface circuits, and the like. The memory 116 is coupled to the CPU 112 and may comprise random access memory, read only memory, removable disk memory, flash memory, and the like. The memory 116 may store many software packages that are simultaneously executed by the server 102. In the embodiment of the invention, the media protection software 122 is stored in memory 116. The media protection software 122 comprises a variety of modules, including a media file player 120, media file manipulation scripts 120, and a media file 118 itself. The protected media file would generally be stored upon a disk drive (herein considered part of the memory 118). The protected media file may be delivered to the client through a variety of delivery means that are represented by the arrows.

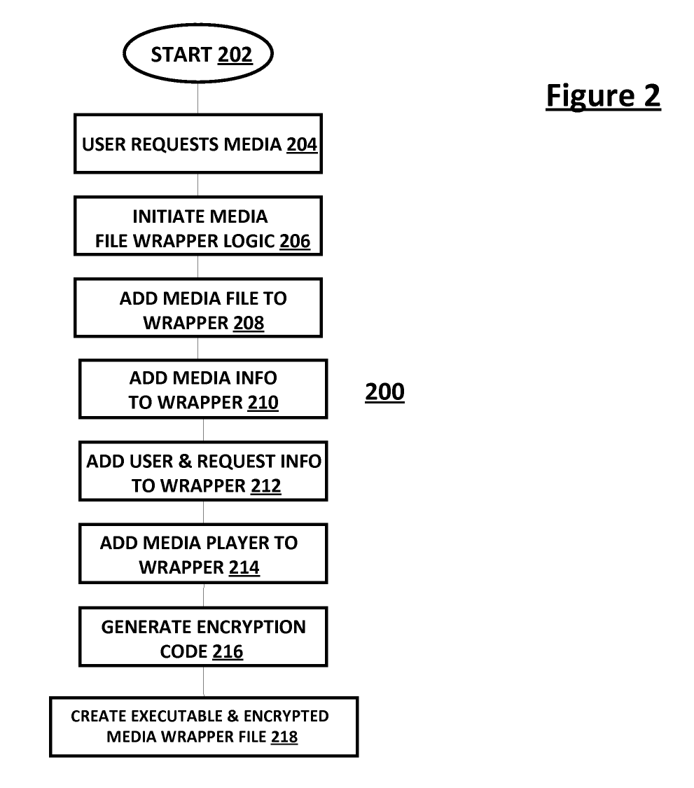

FIG. 2 depicts a flow diagram of a method 200 of operation of the system 100 of FIG. 1 to provide media protection. This method is presented from the viewpoint of the server that creates a protected media wrapper on server computer 102.

The method 200 begins at step 202 and proceeds to step 204 where the user requests a media file from the server. During this request step 204, the user is required to log in and provide security information, as well as identity information, to ensure that the user is authorized to use the service. The user is also required to provide information about accessing the media file, like rental duration and number of devices. Access may also require a pre-paid subscription to the service. All or part of the user provided information may also have been previously stored on the server.

In response to a valid user request, the server initiates the media file wrapping software 122 at step 206. This logic first adds the media file 118 to the wrapper in step 208. The media 118 may have been previously encrypted using a master key known only to the server. Optionally, the wrapping logic can add a smaller representation of the media to the file. This representation may be an image—for example, album cover art, poster or picture of the artist. It could also be a smaller sample of the media itself—for example, a snippet of a video, trailer of a movie, audio sample, or commentary. This representation may or may not be added in encrypted form. Usually it is not encrypted.

At 210, any information pertaining to the media, including any master keys, is added to the wrapper. This information may include, but not limited to, copyright information, server information, media attributes and media owner information. This media information may also be encrypted using keys only known to the server. These keys may be different from the ones mentioned previously.

At step 212, the server then adds all or part of user provided information of step 204 to the wrapper. This information may also be encrypted using either using a new set of keys or using the same keys as previously mentioned.

The server now adds a media player to the wrapper at 214. This media player may be a generic media player or a specialized player designed to work within the present invention. The media player is configured to play the media previously added to the wrapper. The player can also be configured to play the media in its encrypted form, with the help of the media information.

The protection software now generates an encryption code at 216. This code may take any of many possible forms—128-bit character encryption code, 512-bit bit-string, or user provided pass code.

The logic now takes the previously built wrapper and generated encryption code and combines them to create a media protection wrapper at step 218. This could be achieved using customized logic or software available in the market like the ones from Digital River. This step also takes input from the user information provided in 204.

At 218, the media protection logic now creates an executable file that consists of the media protection wrapper created in previous step. This step may also encrypt the wrapper using additional or same keys as previously used.

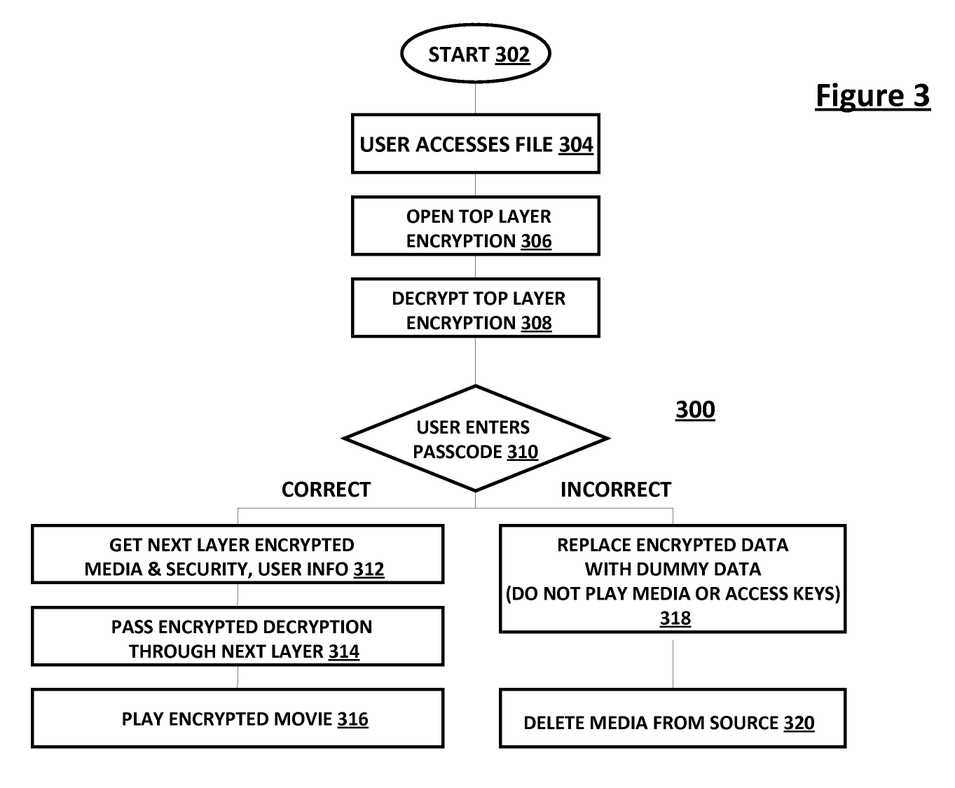

FIG. 3 depicts a flow diagram of a method 300 of operation of the system 100 of FIG. 1 to provide media protection. This method is presented from the viewpoint of the client (and user) 104 that downloads and plays a protected media wrapper from server computer 102 through the computer network 106.

When a user downloads a protected media file to his computer 104, it is in the form of a stand-alone executable file. At 304, the user executes the media file wrapper.

At 306, the top level encryption, if any, is decrypted. This results in another file that is also usually in an encrypted form. This encryption was done using the pass-code provided by the user during the download process.

In the next step 310, the user is asked to enter the pass-code.

If the provided pass-code is incorrect, the method moves on to step 318. Here one of the scripts embedded in the wrapper is used to replace the encrypted media with random or useless dummy data. This renders the media file unusable. In another embodiment, the described actions are taken only if the user enters the pass-code incorrectly more than a certain number of times. During this step the system in 100 also makes sure that neither the media nor any sets of decryption keys are accessed. This ensures that there is no snooping in case of incorrect pass-codes.

If so specified in the media information contained in the wrapper file, the system deletes the media from the client computer 104 in step 320.

If the user specifies the correct pass-code in step 310, the method moves on to step 312. In this step, the next layer of encryption is decrypted. This results in getting the media file 118 and the user information added in 212. Both these components could be in an encrypted form.

The next step 314 checks the user information with the server 102. It is expected that the information will match. If it does not, media is not played. This step also checks the rental duration and other media attributes. If any of this information is found to be out of order, user is not allowed to continue further.

The media file, which could be in encrypted form using software like Digital River, is then played using the media player contained in the wrapper itself.

When the media is being played, a script contained in the wrapper is also executed. This script keeps checking for any software or process on the client computer 104 that might record or store the playing media using surreptitious means. If such a software or process is found, the playing of the media is immediately stopped and the culprit software or process is deleted. Additionally, the media itself could be deleted or replaced with dummy data. The incident may also reported to the server 102.

While the foregoing is directed to embodiments of the present invention, other and further embodiments of the invention may be devised without departing from the basic scope thereof, and the scope thereof is determined by the claims that follow.

What is claimed is:

1. A computer implemented method for achieving a wrapping of files comprising at least one media player, at least one image file background viewer, user information, at least one license key, at least one pass code checksum field, at least one media file, media file's rental period, at least one script, a checksum for validation, a timestamp.

2. The method of claim 1, wherein the media file is at least one of audio file, video file, image file.

3. The method of claim 1, wherein media player can play the media file embedded in the wrapper.

4. The method of claim 1, wherein the media player has one or more functionality to Play media, Fast Forward Media, Rewind Media, Stop Media, Pause, Media, Play Media at various Speed, and buttons allowing the User to Increase the Play Size of media to Full Screen.

5. The method of claim 1, wherein user information consists at least one of user name, user address, user birth date, user credit card information, user email address.

6. The method of claim 1, wherein the script contained in the wrapper file consists at least one of a file deletion script, system optimization script, software key verification script, deicing detection script, debugging detection script, date modification detection script, user validation script.

7. The method of claim 1, wherein
the media file is encrypted with a randomly generated encryption key
the user information and license key is encrypted with a randomly generated encryption key.

8. The method of claim 1, wherein the media player is built with at least one code readers embedded.

9. The method of claim 1, wherein:
the file wrapping is created by compiling the constituent files
the compiled files are encrypted
the encrypted files are scrambled
the compiled, encrypted, scrambled files are combined into one executable file.

10. The method of claim 1, wherein:
all constituent files are encrypted with a randomly generated key.

11. The method of claim 1, wherein the key pairs of encryption are broken into one or more random parts wherein
the location of the parts of the key pair are stored in top layer decryption mechanism
the top layer system is again encrypted with a randomly generated key pair.

12. The method of claim 1, wherein the file wrapper is either provided to the user on a removable media or is resident on a server and provided to the user to be downloaded over a computer network.

13. The method of delivering the file wrapper of claim 1, wherein along with the file wrapper, a key code is provided to the user at the time of purchase via a text message such as email or in person.

14. The method of claims 1 & 13, wherein during the purchase, at least one of user information and license key is stored in a database on a server.

15. The method of detecting a valid user of file wrapper of claim 1, wherein:
user enters a key code and the key code is checked with the key code present in the file wrapper;
the user computer connects to a server to verify the user information stored in the server with that of the current user; and
the user computer connects to a server to verify that the rental period for the media file for the user has not expired.

16. The method of claim 15, wherein when key code and user information matches that entered by the user and when rental period has not expired, the user is allowed to play the media file embedded in file wrapper by the player embedded in the file wrapper.

17. The method of claim 15, wherein the user is allowed to play the media file for the rental period embedded in the file wrapper, if either key code entered by user does not match that in the file wrapper or the user information entered by the user does not match with what is stored in the server or when the rental period has expired, the user is not allowed to play the media file embedded in file wrapper.

18. The method of claim 1, wherein:
the wrapper file contains a script that continuously checks the date and time of the user computer to ensure that the user computer is not out of sync with server time and the time embedded in the wrapper file;
the script in wrapper file also stores date and time the media file was accessed last in the registry and within a hidden encrypted file; and
if user attempts to tamper the hidden file or extend the rental period of the file, the wrapper file will become unusable or it will be deleted from user's computer.

19. The method of claim 1, wherein the wrapper file contains a deicing and debugging script that constantly checks the system to ensure that:
a hacking program isn't trying to decompile the wrapper file on a production level machine; and
a software program that captures the media of the user computer isn't running.

20. The method of claim 19, wherein if such hacking software is detected the hacking program is killed or the wrapper file will be made unusable or will be deleted from user's computer.

21. The method of claim 1, wherein the wrapper file contains a deletion script that has at least one of these abilities:
ability to replace the wrapper file with a useless file; and
ability to delete the wrapper file from user's computer.

22. The method of claim 1, wherein the player in wrapper file displays a link that user can click in order to purchase the media file or to extend the rental period.

23. The method of claim 22, wherein once user clicks the link to purchase the software or extend the rental period, the new license key is sent to the user by message such as email and the license key is updated on the server.

24. The method of claim 1, wherein the hardware code of the computer on which the wrapper file is registered is stored on the server so that:
when user tries to copy the wrapper file to another computer, the hardware code of the new computer is checked with the hardware code stored on the server;
when the hardware code stored on the server does not match the hardware code of the user computer, user is asked to register for the new computer for the wrapper file; and
when the hardware code stored on the server matches the hardware code of the host computer, the user is allowed to play the media file.
